(19) United States
(12) Patent Application Publication
(10) Pub. No.: US 2007/0267078 A1
(43) Pub. Date: Nov. 22, 2007

(54) Hydraulic control valve in the form of a cartridge

(75) Inventors: Olivier Collet, Palaiseau (FR); Sebastien Fremiot, Boulogne Billancourt (FR); Alain Treyz, Antony (FR); Olivier Aubault, Chilly-Mazarin (FR)

Correspondence Address: SUGHRUE MION, PLLC, 2100 PENNSYLVANIA AVENUE, N.W., SUITE 800, WASHINGTON, DC, 20037, US

(73) Assignee: MESSIER-BUGATTI, VELIZY VILLACOUBLAY (FR)

(21) Appl. No.: 11/798,840

(22) Filed: May 17, 2007

(30) Foreign Application Priority Data
May 17, 2006 (FR) 06 04432

(51) Int. Cl. F15B 13/04

(52) U.S. Cl. 137/625.69

(57) ABSTRACT

The invention relates to an assembly comprising at least one hydraulic control valve and a body for receiving said hydraulic control valve, the hydraulic control valve including flow orifices and flow control means for putting the flow orifices selectively into hydraulic communication with one another. The hydraulic control valve is in the form of an oblong cartridge, the body includes an open housing adapted to receive the hydraulic control valve in removable manner such that when the hydraulic control valve is in place in the housing, the hydraulic control valve and the housing together define isolated hydraulic chambers into which the flow orifices of the hydraulic control valve open out.

The invention relates to a hydraulic control valve in the form of a cartridge that is designed to be inserted in particular in a hydraulic manifold.

### BACKGROUND OF THE INVENTION

Hydraulic control valves are known, in particular in the field of aviation, that comprise inlet and outlet ports, and flow control means for putting the inlet ports selectively into communication with the outlet ports via at least two connection circuits.

Such hydraulic control valves are used in particular for controlling the lowering and raising of landing gear, in a determined sequence.

In general, hydraulic control valves are inserted in control valve manifolds that are received on separate support plates, in turn connected by associated piping to the hydraulic circuit of the aircraft and including mechanical and hydraulic interface means with the control valve manifolds.

In the event of a hydraulic control valve manifold failing, it is traditionally considered as being a line replaceable unit (LRU) that is suitable for being removed by ground maintenance personnel and replaced by a good control valve manifold.

In order to perform the function of lowering and raising landing gear, it is found that the number of hydraulic control valves can be large. Proposals have indeed between made to group together all of the separate support plates so as to constitute a single support plate that receives all of the hydraulic control valve manifolds, but such a solution is difficult to implement. Proposals have also been made to integrate the hydraulic control valves completely in a single hydraulic manifold, but without it being possible to perform line replacement of the hydraulic control valve. Although that solution is technically feasible, it is not compatible with economic operation of an aircraft. The failure of a single hydraulic control valve would require the entire hydraulic manifold to be replaced, and that is not very satisfactory.

### OBJECT OF THE INVENTION

There is therefore a need for hydraulic components that enable the hydraulic architecture to be compact and lightweight, but that nevertheless allow maintenance to be performed on the aircraft.

### BRIEF DESCRIPTION OF THE INVENTION

In order to achieve this object, the invention provides an assembly comprising at the least one hydraulic control valve and a body for receiving the hydraulic control valve, the hydraulic control valve including flow orifices and flow control means for putting the flow orifices selectively into hydraulic communication with one another, in which the hydraulic control valve is in the form of an oblong cartridge, the body including an open housing adapted to receive the hydraulic control valve in removable manner such that when the hydraulic control valve is in place in the housing, the hydraulic control valve and the housing together define isolated hydraulic chambers into which the flow orifices of the hydraulic control valve open out.

It suffices to provide the body with hydraulic ports that open out into the chambers in order to obtain a hydraulic control assembly that is adapted to connect the hydraulic ports to one another selectively.

The control valve is thus integrated in the body while remaining easily removable: it suffices to remove it from the housing, without it being necessary to make any hydraulic disconnection.

### BRIEF DESCRIPTION OF THE DRAWINGS

The invention can be better understood in the light of the following description given with reference to the figures of the accompanying drawings, in which:

FIG. 1 is a perspective view of a hydraulic manifold receiving at least one hydraulic control valve of the invention;

FIG. 2 is a longitudinal section view of the hydraulic control valve of FIG. 1, in place in its protective case;

FIG. 3 is a longitudinal section view of the FIG. 1 hydraulic control valve, on being put into place in the hydraulic manifold;

FIG. 4 is a view analogous to that of FIG. 3, showing a later step in the installation of the hydraulic control valve in the hydraulic manifold; and

FIG. 5 is a view analogous to FIGS. 3 and 4 showing the hydraulic control valve in place in the hydraulic manifold.

### DETAILED DESCRIPTION OF THE INVENTION

With reference to FIG. 1, the invention is illustrated herein in its application to a hydraulic manifold 1 used for controlling the extension and the retraction of landing gear in an aircraft. The hydraulic manifold 1 has a plurality of hydraulic ports 2, including inlet ports and outlet ports.

The hydraulic manifold 1 shown has a plurality of hydraulic control valves for selectively putting certain inlet ports into communication with certain outlet ports. At the top of the hydraulic manifold 1, there can be seen a conventional hydraulic control valve 3, having its own hydraulic ports, and connected to the hydraulic manifold 1 via a hydraulic manifold 4 constituting a support plate that is fitted onto the hydraulic manifold 1. This control valve of known type acts as a safety valve for connecting the hydraulic manifold to the return in the event of an incident during the sequence of maneuvering the landing gear.

The invention relates to hydraulic control valve 5 (one being shown extracted from the hydraulic manifold 1), that is in the form of an oblong cartridge designed to be received in an open blind housing 6 in the hydraulic manifold 1. In this example, the hydraulic manifold 1 has a plurality of hydraulic control cartridge values 5.

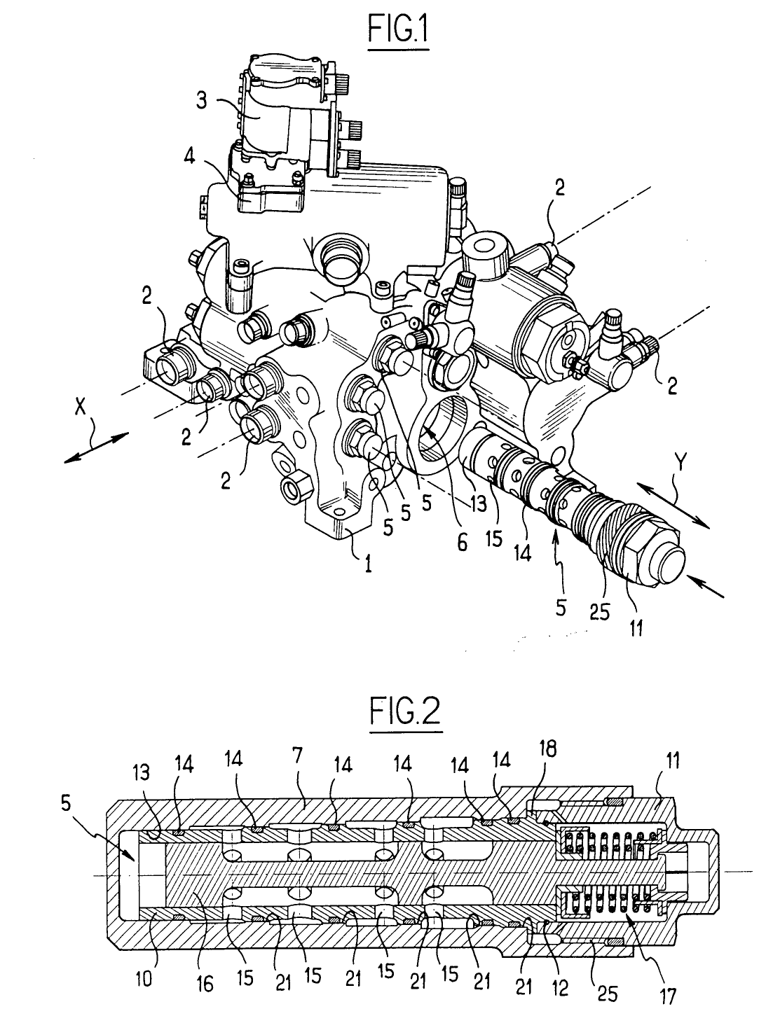

As can be seen in FIG. 2, where the hydraulic control cartridge valve 5 is shown in its protective case 7, the hydraulic control cartridge valve 5 comprises a jacket 10 having a first end carrying a blind fastener nut 11 provided with an outside thread 25. The nut 11 is secured to the jacket 10 by a ring 12 leaving the nut 11 free to rotate relative to the jacket 10. The jacket 10 has a second end forming a centering bearing surface 13.

Between its two ends, the jacket 10 carries a plurality of sealing gaskets 14 that are longitudinally spaced apart on its outside surface, the gaskets being of diameters that decrease going from the first end towards the second end of the jacket 10. The jacket 10 includes a certain number of orifices 15 formed between the sealing gaskets 14.

A spool 16 is mounted to slide in the jacket 10 and it is held in the neutral position (as shown) by a resilient positioning member 17 such as a pair of springs. The axial displacement of the spool 16 against the resilient positioning member 17 on either side of the neutral position serves to put orifices 15 extending on either side of the sealing gaskets 14 selectively into communication with one another. The resilient positioning member 17 bears at one end against the end of the jacket 10 and at its other end against a shoulder on the nut 11.

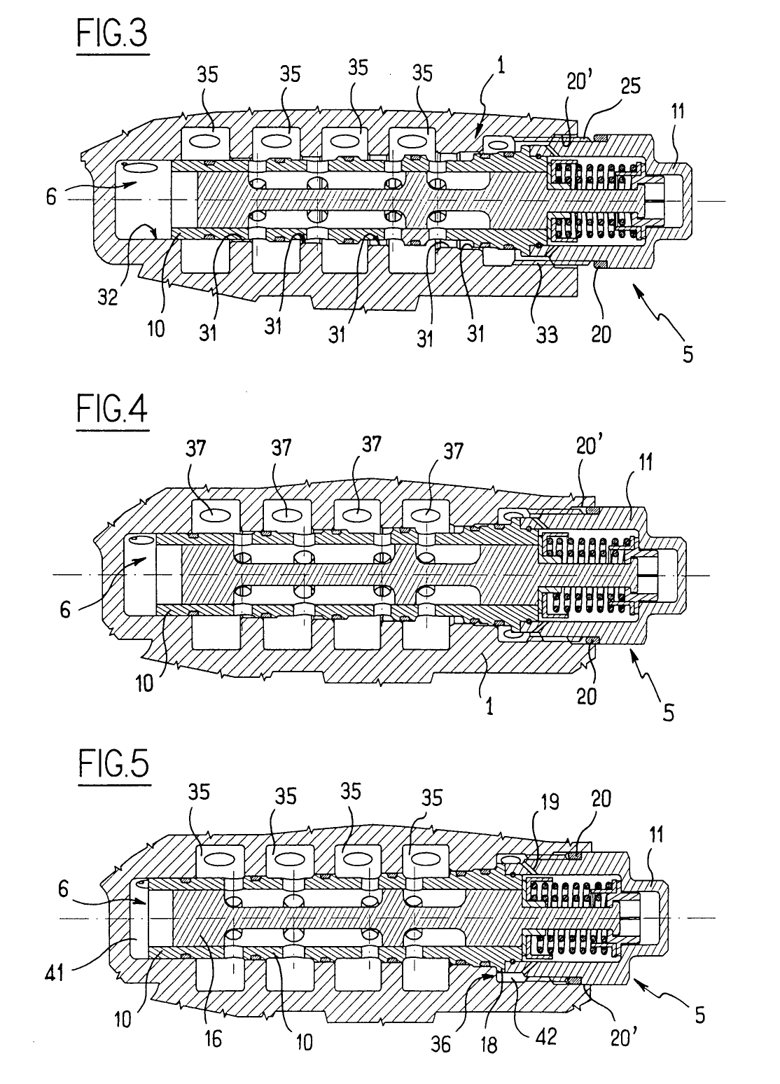

Installing the hydraulic control valve 5 in the housing 6 of the hydraulic manifold 1 is described below in greater detail with reference to FIGS. 3 to 5.

The housing 6 defines a certain number of sealing bearing surfaces 31 designed to co-operate with the sealing gaskets 14. The bearing surfaces 31 are of diameter that decreases going from the inlet of the housing 6 towards the end wall thereof, such that the bearing surfaces 31 are stepped. The end wall of the housing 6 presents a centering bearing surface 32 for co-operating with the centering bearing surface 13 of the jacket 10, and of diameter that is smaller than the diameter of the sealing bearing surfaces 31.

The hydraulic control cartridge valve 5 is engaged in the housing 6 until the centering bearing surface 13 of the jacket 10 co-operates with the complementary centering bearing surface 32 of the housing 6. In so doing, some of the sealing gaskets 14 pass through some of the sealing bearing surfaces 31. The stepped nature of the bearing surfaces 31 serves to avoid the sealing gaskets 14 being damaged as they pass through those bearing surfaces 31 that are of greater diameter.

Thereafter, guided by the co-operation between the centering bearing surfaces 13 and 32, the hydraulic control cartridge valve 5 continues to be pushed in until the thread of the nut 11 comes into abutment against the entry to complementary tapping 33 formed at the inlet of the housing 6, but without yet being engaged therein, as shown in FIG. 3. It should be observed that in this position, none of the sealing gaskets 14 is yet engaged within the bearing surface 31 with which it is to co-operate.

Thereafter, the nut 11 is tightened. Screw-tightening serves to move the hydraulic control cartridge valve 5 progressively into the housing 6, causing the gaskets 14 to become engaged within the bearing surface 31. Once the sealing gaskets 14 come into contact with the bearing surfaces 31, the nut 11 is already engaged sufficiently to be able to exert the force required for engaging said gaskets against their respective bearing surfaces. In FIG. 4, there can be seen the position of the hydraulic control cartridge valve 5 in which the sealing gaskets 14 have just begun to be engaged against the bearing surfaces 31.

The force required for engagement can be considerable, because of the large number of sealing gaskets 14 (six gaskets 14 in the example shown plus an additional gasket 20 associated with the nut 11). Exerting such an engagement force is made easier by the reduction provided by the helical connection between the nut 11 of the hydraulic control cartridge valve 5 and the hydraulic manifold 1, such that reasonable screw-tightening torque enables a large engagement force to be exerted. For this purpose, the ring 12 allows the nut 11 to turn while the jacket 10 remains stationary in rotation, thereby facilitating engagement of the gaskets 14 against the bearing surfaces 31 and avoiding damaging said gaskets by rotation.

As shown in FIG. 5, screw-tightening is continued until an abutment collar 18 of the jacket 10 comes into abutment against an associated shoulder 36 of the housing 6 and becomes pinched between said shoulder 36 and the nut 11. In this position, the sealing gaskets 14 extend against their respective bearing surfaces 31, thereby defining between the control valve and the housing a set of chambers 35 that are hydraulically isolated from one another by the sealing gaskets 14. Each of these chambers 35 has ducts 37 opening out therein (referenced in FIG. 4) that connect said chambers to the hydraulic ports 2 of the hydraulic manifold 1. The chambers 35, and thus the associated hydraulic ports, are put selectively into hydraulic communication by means of a hydraulic path that extends within the hydraulic control cartridge valve 5 between the orifices 15 that open out into one or another of the chambers 35.

It should be observed that the sealing gasket 14 that is closest to the second end of the jacket 10 co-operates with the centering bearing surface 32 such that it too acts as a sealing bearing surface.

According to a particular aspect of the invention, and as can be seen in FIG. 5, the sealing gaskets 14 closest to the ends of the jacket 10 define in the hydraulic manifold 1:

a first pilot chamber 41 in the end of the housing 6 into which there opens out a duct connected to a pilot hydraulic port for moving the spool 16 against the resilient positioning member 17. For this purpose, the end of the jacket 10 is open so that the pressure that exists in the first pilot chamber 41 acts directly on the piston-forming end of the spool 16; and

a second pilot chamber 42 connected to a pilot hydraulic port for moving the spool 16 against the resilient positioning member 17 in an opposite direction. For this purpose, the pressure that exists in the second pilot chamber 42 is transmitted to the inside of the nut 11 via orifices 19 to act directly on the other piston-forming end of the spool 16. The second pilot chamber 42 is sealed by a sealing gasket 20 disposed in the vicinity of the thread of the nut 11, in this example behind it, and co-operating with a complementary bearing surface 20′ provided at the inlet to the housing 6.

In order to remove the hydraulic control cartridge valve 5, it suffices to unscrew it and take it out of the housing. Thus, the hydraulic control cartridge valve of the invention can be put into place and removed without making any hydraulic disconnection, nor does it require any special tooling.

According to a particular aspect of the invention, the hydraulic control cartridge 5, while not installed in a hydraulic manifold, is stored in a protective case 7, as shown in FIG. 2. The protective case defines a housing with tapping at its inlet for co-operating with the thread of the nut 11.

The protective case 7 is partially filled with hydraulic fluid, and like the housing 6 in the hydraulic manifold 1, it includes sealing bearing surfaces 21 for co-operating with the sealing gaskets 14 when the hydraulic control cartridge valve 5 is in place in the protective case 7. Thus, the sealing gaskets 14 are pre-compressed by the bearing surfaces of the protective case 7, but that when the hydraulic control cartridge valve 5 is extracted from the protective case 7 in order to put into place in the housing 6 of the hydraulic manifold 1, the sealing gaskets 14 do not have enough time to return to their initial shape, thereby making it easier to engage said sealing gaskets against the sealing bearing surfaces 31 of the housing 6.

According to another aspect of the invention, it can be seen in FIG. 1 that the hydraulic ports 2 extend in a first direction X in line with the associated ducts 37 (which can be seen opening out into the chambers 35 in FIGS. 3 to 5), while the hydraulic control cartridge valves 5 and the associated housings 6 extend along a direction Y that is perpendicular to the direction X, thereby considerably facilitating design of the hydraulic manifold.

The invention is not limited to the above description, but on the contrary covers any variant coming within the ambit defined by the claims.

In particular, although the description above relates to a control valve having sliding spool type control means, the invention is applicable to other types of control valves, such as poppet valves.

Although the control valve and the hydraulic manifold described define two pilot chambers, it is possible to make a control valve that has only one pilot chamber.

More generally, although it is stated that the hydraulic control cartridge valve is designed to be received in the housing of a hydraulic manifold or of a protective case, it is possible to put the control valve in place into any body that includes a suitable housing.

What is claimed is:

1. An assembly comprising at least one hydraulic control valve and a body for receiving said hydraulic control valve, the hydraulic control valve including flow orifices and flow control means for putting the flow orifices selectively into hydraulic communication with one another;
wherein the hydraulic control valve is in the form of an oblong cartridge, the body including an open housing adapted to receive the hydraulic control valve in removable manner such that when the hydraulic control valve is in place in the housing, the hydraulic control valve and the housing together define isolated hydraulic chambers into which the flow orifices of the hydraulic control valve open out.

2. An assembly according to claim 1, in which:
the control valve carries sealing gaskets that are longitudinally spaced apart; and
the housing defines sealing bearing surfaces for co-operating with the sealing gaskets when the hydraulic control valve is in place in said housing, the chambers extending between the sealing gaskets;
and in which the sealing bearing surfaces and gaskets present stepped diameters that decrease going from an inlet to the housing towards an end wall of the housing.

3. An assembly according to claim 1, in which the hydraulic control valve has a first end carrying fastener means for fastening the hydraulic control valve in the housing of the body.

4. An assembly according to claim 2, in which the fastener means comprise a nut mounted to rotate on a jacket of the hydraulic control valve, and including a thread to co-operate with tapping extending at the inlet to the housing.

5. An assembly according to claim 1, in which the control valve has a second end including a centering bearing surface for co-operating with a complementary centering bearing surface extending at the end of the housing.

6. An assembly according to claim 4, in which the control valve has a second end including a centering bearing surface for co-operating with a complementary centering bearing surface extending at the end of the housing, and in which the control valve is arranged in such a manner that when the thread comes into abutment against the tapping without being engaged therein, the sealing gaskets do not yet bear against the sealing bearing surfaces of the housing, but the centering bearing surfaces co-operate for centering the hydraulic control valve in the housing.

7. An assembly according to claim 6, in which, once the thread is engaged in the tapping and when the sealing gaskets come into contact with the sealing bearing surfaces, the nut is sufficiently engaged to be capable of exerting the force required to engage said gaskets against their respective bearing surfaces.

8. An assembly according to claim 4, in which the jacket includes a collar extending immediately in register with the nut so as to pinched between said nut and a shoulder of the housing when the control valve is in place in the housing.

9. An assembly according to claim 4, in which the nut carries a sealing gasket disposed in the vicinity of the thread and designed to bear against an inlet bearing surface of the housing.

10. An assembly according to claim 1, in which the body is a hydraulic manifolds having hydraulic ports associated with ducts that open out into the chambers.

11. An assembly according to claim 10, in which the hydraulic control valve and the associated housing extend in the hydraulic manifold in a first direction, while the ducts extend in a second direction perpendicular to the first.

12. An assembly according to claim 1, in which the body is a protective case for the hydraulic control valve.
